(19) United States
(12) Patent Application Publication
(10) Pub. No.: US 2007/0024408 A1
(43) Pub. Date: Feb. 1, 2007

(54) Adjustable temperature switch

(75) Inventor: Grace Lee, Chia Yi Hsien (TW)

Correspondence Address: STITES & HARBISON PLLC, 1199 NORTH FAIRFAX STREET, SUITE 900, ALEXANDRIA, VA, 22314, US

(73) Assignee: HOMEEASE INDUSTRIAL CO., LTD.

(21) Appl. No.: 11/221,909

(22) Filed: Sep. 9, 2005

(30) Foreign Application Priority Data
Jul. 29, 2005 (TW) 94,213,005

(51) Int. Cl. H01H 37/12; H01H 37/52

(52) U.S. Cl. 337/360

(57) ABSTRACT

An adjustable temperature switch includes a temperature-adjusting device. The temperature-adjusting device includes a rotatable adjusting block and a knob engaged with the rotatable adjusting block. The knob includes an end face with a plurality of partitions separated by a plurality of partitioning ribs. A resilient member includes a first end fixed to the temperature-adjusting device and a hooked second end retained in one of the partitions.

### BACKGROUND OF THE INVENTION

1. Field of the Invention

The present invention relates to an adjustable temperature switch. More particularly, the present invention relates to an adjustable temperature switch for an electric appliance such as a hot melt gun.

2. Description of the Related Art

FIG. 3 of the drawings illustrates a hot melt gun with a conventional adjustable temperature switch that includes a temperature-adjusting device 1′ mounted in a body 4′ of the hot melt gun for adjusting the temperature for melting a solid glue stick into liquid. The temperature-adjusting device 1′ comprises a wire 2′ for electrical connection with a heating member 3′. The temperature-adjusting device 1′ further includes an adjusting block 11′ with an outer threading 111′. Engaged on the adjusting block 11′ is a knob 112′ having an annular groove 113′ for coupling with the body 4′, allowing on-site rotation of the knob 112′. A fixed plate 12′ is mounted in the body 4′ and includes a screw hole 121′ for threadedly engaging with the outer threading 111′ of the adjusting block 11′. Also mounted in the body 4′ is a bimetal plate 13′ having different bending extends at different temperatures. The bimetal plate 13′ is electrically connected to an electrode, and a metal plate 14′ mounted in the body 4′ is electrically connected to the other electrode.

When the knob 112′ is turned, the adjusting block 11′ is moved toward or away from the bimetal plate 13′ to thereby cause the bimetal plate 13′ to be in tight contact or loose contact with the metal plate 14′. When the knob 112′ is turned, e.g., clockwise, the adjusting block 11′ is turned and moved away from the bimetal plate 13′ and causes the bimetal plate 13′ to be in tight contact with the metal plate 14′. In this case, greater bending of the bimetal plate 13′ at a relatively high temperature is required to cause disengagement of the bimetal plate 13′ from the metal plate 14′ to cut off electricity supply to the heating member 3′.

On the other hand, when the knob 112′ is turned in a revere direction, the adjusting block 11′ is turned and moved toward the bimetal plate 13′ and causes the bimetal plate 13′ to be in loose contact with the metal plate 14′. In this case, slight bending of the bimetal plate 13′ at a relatively low temperature is sufficient to cause disengagement of the bimetal plate 13′ from the metal plate 14′ to cut off electricity supply to the heating member 3′.

However, the knob 112′ is exposed and thus liable to be inadvertently impinged and turned. Such unintentional rotation of the knob 112′ is not desired and causes problems.

### SUMMARY OF THE INVENTION

An objective of the present invention is to provide an adjustable temperature switch for an electric appliance in which unintentional rotation of the knob of the adjustable temperature switch is avoided.

An adjustable temperature switch in accordance with the present invention comprises a temperature-adjusting device. The temperature-adjusting device comprises a rotatable adjusting block and a knob engaged with the rotatable adjusting block. The knob comprises an end face with a plurality of partitions separated by a plurality of partitioning ribs. A resilient member comprises a first end fixed to the temperature-adjusting device and a hooked second end retained in one of the partitions.

Unintentional rotation of the knob is avoided, as it requires a considerable force to turn the knob. When a user forcibly turns the knob, the respective partitioning ribs push the hooked second end of the resilient member away from one partition in which the hooked end is originally retained. Then, the hooked second end of the resilient member clicks and returns to its original position and thus engaged in the next partition. Thus, the user may be aware of the adjusting extent of the adjustable temperature switch.

Other objectives, advantages, and novel features of the invention will become more apparent from the following detailed description when taken in conjunction with the accompanying drawings.

### BRIEF DESCRIPTION OF THE DRAWINGS

FIG. 1 is an exploded perspective view of an adjustable temperature switch in accordance with the present invention.

FIG. 2 is a sectional view of a hot melt gun with the adjustable temperature switch in accordance with the present invention.

FIG. 3 is a sectional view of a hot melt gun with a conventional adjustable temperature switch.

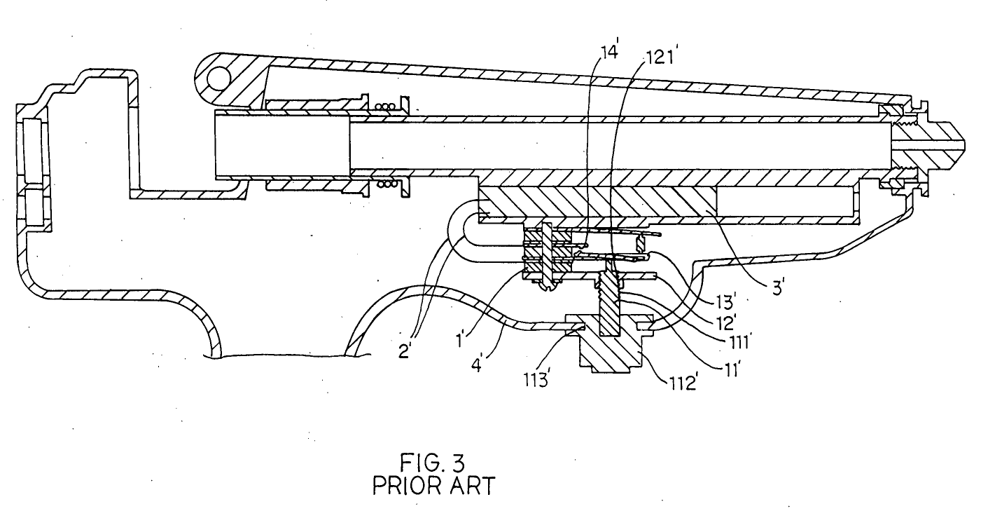

### DETAILED DESCRIPTION OF THE PREFERRED EMBODIMENT

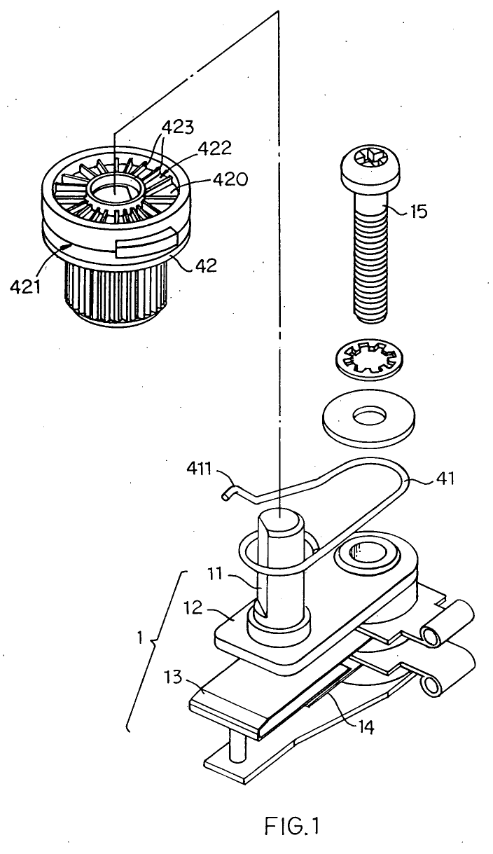

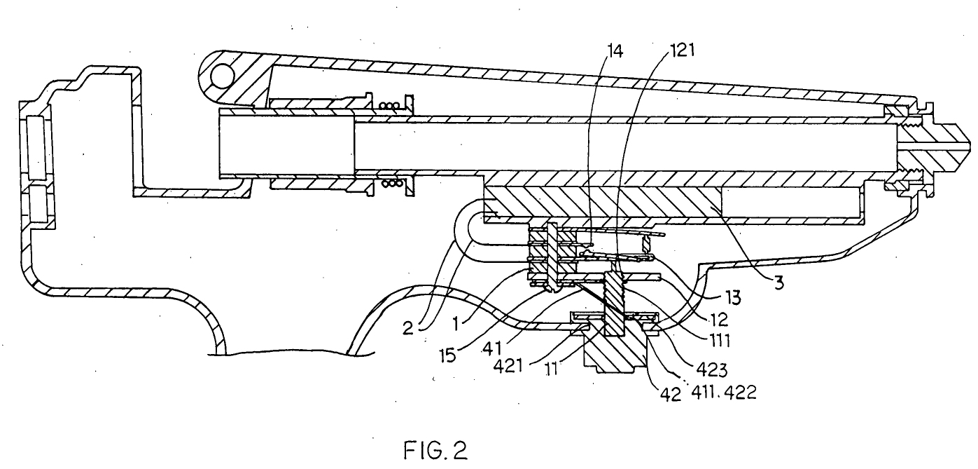

Referring to FIGS. 1 and 2, an adjustable temperature switch in accordance with the present invention comprises a temperature-adjusting device 1 that is electrically connected by a wire 2 to a heating member 3 and that comprises an adjusting block 11 with an outer threading 111. A knob 42 is mounted to an end of the adjusting block 11 and comprises an annular groove 421 for coupling with a body 4 of a hot melt gun. Thus, the knob 42 is rotatably held by the body 4 of the hot melt gun.

A fixed plate 12 is mounted in the body 4 and comprises a screw hole 121 for threadedly engaging with the outer threading 111 of the adjusting block 11. Also mounted in the body 4 is a bimetal plate 13 having different bending extends at different temperatures. The bimetal plate 13 is electrically connected to an electrode, and a metal plate 14 mounted in the body 4 is electrically connected to the other electrode.

When the knob 42 is turned in a direction, the adjusting block 11 is turned and moved away from the bimetal plate 13 and causes the bimetal plate 13 to be in tight contact with the metal plate 14. In this case, greater bending of the bimetal plate 13 at a relatively high temperature is required to cause disengagement of the bimetal plate 13 from the metal plate 14 to cut off electricity supply to the heating member 3.

On the other hand, when the knob 112 is turned in a revere direction, the adjusting block 11 is turned and moved toward the bimetal plate 13 and causes the bimetal plate 13 to be in loose contact with the metal plate 14. In this case, slight bending of the bimetal plate 13 at a relatively low temperature is sufficient to cause disengagement of the bimetal plate 13 from the metal plate 14 to cut off electricity supply to the heating member 3.

Of more importance, the temperature-adjusting switch comprises a resilient member 41 and the knob 42 comprises a plurality of partitions 422. An end of the resilient member 41 is fixed on the temperature-adjusting device 1, and the other end 411 of the resilient member 41 is hooked.

As illustrated in FIG. 1, the partitions 422 are defined in an end face 420 of the knob 42 and separated by a plurality of partitioning ribs 423. Thus, a partition 422 is delimited by a pair of partitioning ribs 423 adjacent to each other. The hooked end 411 of the resilient member 41 is retainable in one of the partitions 422, thereby preventing unintentional rotation of the knob 42. More specifically, when a user forcibly turns the knob 42, the respective partitioning ribs 423 push the hooked end 411 of the resilient member 41 away from one partition 422 in which the hooked end 411 is originally retained. Then, the hooked end 411 of the resilient member 41 clicks and returns to its original position and thus engaged in the next partition 422. Thus, the user may be aware of the adjusting extent of the adjustable temperature switch. Further, unintentional rotation of the knob 42 is avoided, as it requires a considerable force to turn the knob 42.

Although a specific embodiment has been illustrated and described, numerous modifications and variations are still possible without departing from the essence of the invention. The scope of the invention is limited by the accompanying claims.

What is claimed is:

1. An adjustable temperature switch comprising a temperature-adjusting device, the temperature-adjusting device comprising a rotatable adjusting block and a knob engaged with the rotatable adjusting block, the knob comprising an end face with a plurality of partitions separated by a plurality of partitioning ribs, a resilient member comprising a first end fixed to the temperature-adjusting device and a hooked second end retained in one of the partitions.
